(19) United States
(12) Patent Application Publication
(10) Pub. No.: US 2026/0061430 A1
(43) Pub. Date: Mar. 5, 2026

(54) SYSTEM AND PROCESS FOR DRY MAGNETIC CONCENTRATION OF FINE IRON ORE CONCENTRATES

(71) Applicant: VALE S.A., Botafogo, Rio de Janeiro (BR)

(72) Inventors: Benito Barbabela E SILVA, Pedro Leopoldo (BR); Fabiano DE CARVALHO FILHO, Nova Lima (BR); Anderson de Araujo SOARES, Belo Horizonte (BR); Augusto Miranda DE RESENDE, ltabirito (BR); Mauro Fumio YAMAMOTO, Rio de Janeiro (BR)

(21) Appl. No.: 18/852,407

(22) PCT Filed: Apr. 1, 2022
(86) PCT No.: PCT/BR2022/050118

§ 371 Date: Oct. 6, 2025

(30) Foreign Application Priority Data
Mar. 30, 2022 (BR) BR102022006041-0

(51) Int. Cl. B03C 1/025; B03C 1/20; B03C 1/30

(52) U.S. Cl. CPC B03C 1/025; B03C 1/20; B03C 1/30

(57) ABSTRACT

The present invention relates to a system and process for dry magnetic concentration from fine iron ore concentrate. More precisely, the present invention deals with a reprocessing/cleaner route for pellet feed enrichment by providing a system for improving/increasing the efficiency of the cleaner step of concentrating pellet feed from previous mineral concentration steps and comprising a drying unit, a cooling unit and a magnetic separation unit, wherein the supplied pellet feed has a content of about 58% to about 64% Fe and reaches high purity contents of more than 67.5%.

### FIELD OF THE INVENTION

The present invention deals with a system and process for dry magnetic concentration from fine iron ore concentrates (pellet feed) to obtain high purity concentrates. More specifically, the present invention constitutes a reprocessing/cleaner route for pellet feed enrichment.

### FUNDAMENTALS OF THE INVENTION

In the mining industry, the term pellet feed refers to the fine fractions of iron ore with 90% of the particles smaller than 150 μm, and are commonly destined for the pelletizing process, which requires a step of regrinding these particles to fractions larger than 60% below 45 μm. Alternatively, pellet feed can also be processed together with sinter feed (with particle size fractions mostly ranging from 0.150 mm to 6.35 mm) in sintering, with participation usually limited to 40%.

The hematite ore stoichiometry presents the maximum value of 69.94% Fe (T), in comparison to the commercialized pellet feed with contents varying between 58 and 64% Fe (T) and contents for contaminants such as silica (SiO₂) and alumina (Al₂O₃) of about 11.94% and 5.94%, respectively. The presence of these contaminants in reduction furnaces considerably increases the consumption of reducing agent and of meltings and, consequently, they operate with higher greenhouse gas (GHG) and steel mill waste generation. Steel mill residues are considered class 1 and/or class 2 non-inert and require controlled disposal.

The iron ore beneficiation process used in the mining industry generally consists of a flotation separation process in stages known as rougher, scavenger, and cleaner, and their various combinations, in order to obtain a concentrate with the desired specifications, combined with a prior or subsequent stage of wet electromagnetic separation (WHIMS) or even only through wet electromagnetic separation (WHIMS).

Current high intensity rare earth permanent magnet drum and roller-type dry magnetic separators show good efficiency for fractions above 150 μm and some roller-type magnetic separators are satisfactory for fractions above 75 μm.

It is worth mentioning that magnetic separation is a process in which two or more materials of different magnetic susceptibilities are separated from each other, in which the main driving force is the magnetic force (Fm). Besides the magnetic force, other forces also act on the particles, such as centrifugal force (Fc) and gravitational force (Fg). In this context, a particle is considered magnetic when Fm>Fc+Fg. For particles smaller than 150 μm, the magnetic force is mostly greater than the centrifugal force. Moreover, as will be recognized by those skilled in the technique, the fine particles, in addition to having lower centrifugal force, still suffer influence from the magnetic field, so that the smaller its diameter the greater this influence will be, which also leads to the conduction of non-magnetic fine particles to a zone intended for the reception of magnetic particles. In view of this, magnetic separation of iron ore fines below 150 μm is still a challenging scenario, since conventional separation systems are inefficient to obtain concentrates with economically viable iron contents.

Conventional magnetic separation equipment generally has a splitter, generating a magnetic and a non-magnetic product. The prior art also encompasses magnetic separation equipments that contain two splitters, generating a third mixed product.

Patent document BR102012008340-0, also owned by the Applicant, discloses a magnetic separation system and unit for the recovery of iron ore fines. Said magnetic separation unit operates successive separations with generation of non-magnetic, mixed and magnetic fractions. However, this state of art document teaches the feed control of the magnetic separation unit by varying the vibration intensity of the vibratory motor installed in it, which does not always result in an adequate flowability of the material. Furthermore, this document deals with a fed material that is different from the pellet feed and, thus, requires an additional stage of sorting, prior to magnetic separation, by means of cycloning. Moreover, this document is silent about the configuration of splitters in the magnetic separation unit as a control and optimization resource of the separation.

Document U.S. Pat. No. 5,961,055 is directed to methods and systems for dry separation of magnetic material (including iron ore) from mixtures containing non-magnetic material. Within this scope, this document discloses methods that implement multi-stage magnetic separation involving multiple rounds of magnetic separation, with optional sorting. Furthermore, this document teaches that dry material can be initially separated by means of a low intensity magnetic field, followed by subsequent high intensity magnetic fields for additional magnetic separations. However, this document mentions magnetic drum separators, and because of this, it has limitations with respect to fine materials.

The scientific paper entitled “COMPARISON BETWEEN CONCENTRATION ROUTES: FLOTATION X MIXED CIRCUITS” proposes a mixed route of iron ore concentration, in which the rougher and scavenger steps are performed in magnetic or electromagnetic separators and the cleaner step is performed by flotation. The results presented confirm the potential of the mixed circuit to increase the mass and metallurgical recovery when compared to the concentration circuit consisting only of flotation. In this scope, a product with 66.76% of Fe content was achieved. However, this document mentions the use of electromagnetic carousel separators (WHIMS)—i.e. operating in wet mode, and proposes the application of magnetic or electromagnetic separation before the flotation stage-thus indicating the possibility of eliminating the desliming stage.

As exposed above, there are efforts in the state of the art dedicated to the implementation of systems comprising magnetic concentration of iron ore fines, conjugated or not with flotation, seeking to obtain economically and environmentally viable iron concentrate products. In this context, the present invention proposes a process for obtaining high purity iron ore concentrates and contributes to the reduction of greenhouse gases (GHG) and of generation of steel mill waste. Furthermore, it should be pointed out that the present invention provides a rational use of natural resources as well as the utilization of the generated waste for use in the building industry and with great water savings, since it is conducted absolutely dry.

In this scenario, as will be better detailed below, the present invention provides an integrated system that allows obtaining high quality concentrates, also enabling a significantly positive environmental impact in the scope of the dry concentration route and the reuse of the generated tailings.

### SUMMARY OF THE INVENTION

The present invention provides a system and process route for producing a high quality pellet feed. More precisely, the present invention provides a dry reprocessing/cleaner route for magnetic concentration of fine iron ore concentrates.

In this context, the present invention aims to provide a system and process for improving/increasing the efficiency of the cleaner step of concentrating pellet feed coming from previous mineral concentration steps, such as flotation and/or wet magnetic or electromagnetic concentration (WHIMS or similar), providing high metallurgical and mass recoveries. More precisely, the present invention starts from pellet feed concentrates with Fe (T) contents ranging from about 58% to about 64% (commonly priced on the standard 62% content) to obtain an iron oxide ore concentrate product with Fe (T) contents above 67.5%.

The present invention has the further purpose of providing a dry reprocessing/cleaner route that dispenses the use of water as a resource and the need for tailings allocation in tailings dams. Effectively, the present invention aims at the absence to minimizing of environmental liabilities, since the generated tailings can be used in the building industry or, depending on the quality obtained, in the steel industry.

The mentioned objectives and other advantages of the present invention will become more evident from the description that follows.

### BRIEF DESCRIPTION OF THE DRAWINGS

FIG. 1 shows a simplified operational flow diagram of the route for concentrating fine iron ore concentrate of the present invention.

FIG. 2 shows the rapid dryer with mechanical agitation system used as one of the alternatives in the process of the present invention.

FIG. 3 shows a simplified schematic configuration of the magnetic roller according to the present invention.

FIG. 4 shows a detailed design configuration of the magnetic roller according to the present invention.

FIG. 5 shows the cascaded arrangement of four magnetic rollers according to the present invention.

FIG. 6 shows the positioning configuration of the splitters for four magnetic rollers according to the present invention.

FIG. 7 shows the configuration of magnet thicknesses and air gap thicknesses for four magnetic rollers according to the present invention.

FIG. 8 shows the configuration of magnetic field lines, gradient (depth of magnetic field), magnetic intensity graph and the points of highest magnetic intensity versus the retention area of the magnetic minerals.

FIG. 9 shows the designed and constructed of a block of four magnetic separators according to the present invention.

### DETAILED DESCRIPTION OF THE INVENTION

In order to achieve the objectives described above, the present invention provides a system and process for dry magnetic concentration of fine iron ore concentrates.

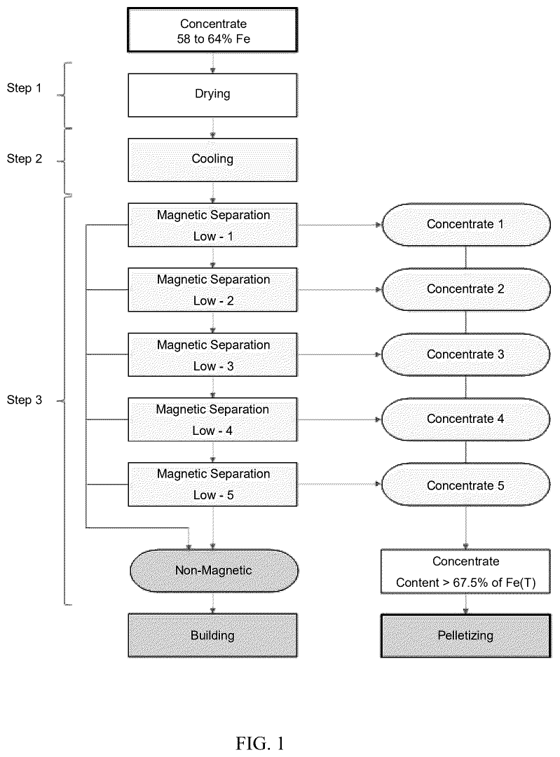

More precisely, the present invention provides a process and a system for dry magnetic concentration of pellet feed comprising: a drying unit, a cooling unit and a magnetic separation unit. FIG. 1 shows a simplified flow diagram of the process route for concentrating fine iron ore concentrate of the present invention.

The drying unit is intended to promote good dispersion and prevent the formation of pellets and comprises a dryer selected from the group consisting of rapid dryer with mechanical agitation system, Flash Dryer, rotary, fluidized bed or the like.

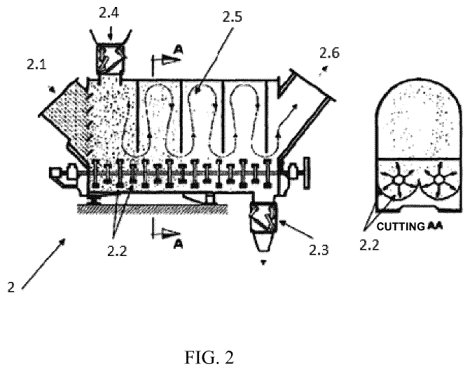

FIG. 2 shows a rapid dryer with mechanical agitation system 2 comprising agitator shafts 2.2 that drive the particles in contact with the hot gas, promoting quick heat exchange and efficient drying. The hot gas is introduced through inlet 2.1 and a baffle system 2.5 enables the heated gas to come into contact with the wet ore, which is fed through inlet 2.4 and released as dry ore through outlet with double pendulum valve 2.3. The saturated wet gas, in its turn, is released at outlet 2.6.

In the case of the Flash Dryer, for example, pellet feed is suspended within a column by dragging hot air from a hot gas generator.

According to the present invention, the dryer is sized so that the residence time is sufficient for the pellet feed moisture to be residual, i.e., moisture equal to or less than 0.5% (b.u., read wet basis).

The dryers' thermal source, in its turn, comes from the combustion of natural gas, coal, charcoal, coke, fuel oils, diesel, liquid or gaseous steel or petrochemical coproducts such as tar, anthracene oil, blast furnace top gas, coke oven gas, among others.

In a preferred embodiment, the drying step is conducted at a temperature in the range of about 80° C. to about 120° C.

At the end of the drying process, a process exhauster promotes forced convection of the gas flow. In this process, as well as in the gas exits from the dryers, fines can be collected in high-efficiency cyclones. The cyclone gases go through a dedusting process in which the particles mostly smaller than 10 μm are retained in a process sleeve filter or electrostatic precipitator.

Then, the injection of cold air will promote the cooling of the ore for the next stage of magnetic separation. The cooling aims to preserve the magnetic intensity of the rare earth magnets, concerning the subsequent magnetic separation step, which may suffer demagnetization at temperatures above 80° C. According to the present invention, the cooling is conducted in static or dynamic air classifiers, rotary coolers, column flash coolers or fluidized bed coolers, with admission of atmospheric air at room temperature.

In a preferred embodiment, in the cooling step, the pellet feed temperature is reduced to less than 65° C.

Optionally, the present invention comprises an air-sorting unit in conjunction with the cooling unit to conduct the cutting of the extremes, for example, of particles below 10 μm or above 150 μm.

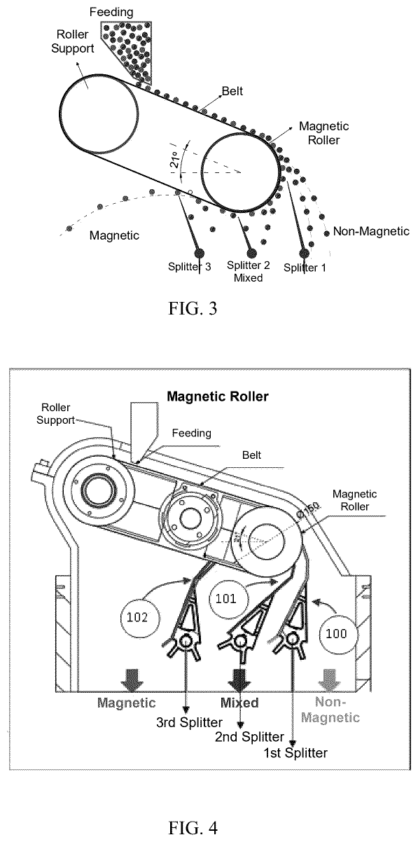

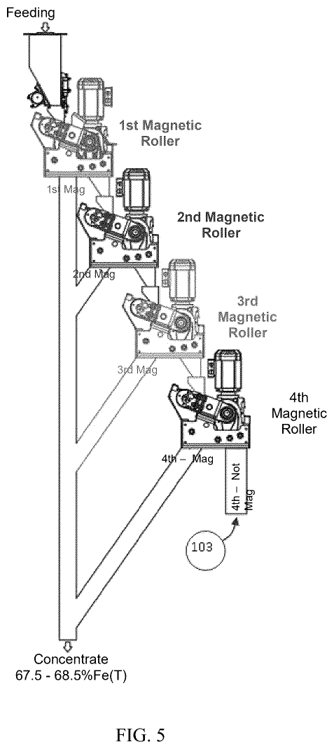

Magnetic separation unit is controlled by means of splitters. In a preferred embodiment, the magnetic rollers of the present invention have at least three splitters that separate the non-magnetic fractions, the mixed fractions and the magnetic fractions. FIG. 3 schematically and in a simplified manner shows the magnetic roller with the arrangement of three splitters. The fraction collected to the left of splitter 3 is the magnetic fraction, the fraction collected between splitter 3 and splitter 2 is the mixed fraction, and the fraction collected to the right of splitter 1 is the non-magnetic fraction.

In addition to “trapping”, which is the unwanted drag of non-magnetic particles along with magnetic particles, there is also unwanted drag caused by the vacuum formed due to the high speed of the magnetic roller. In this context, splitter 2 is not intended to generate product, but rather to provide a barrier to unwanted particle drag.

FIG. 4 shows a more detailed configuration of a magnetic roller according to the present invention and the arrangement of three splitters 100, 101 and 102 thereof. The combination of the roller speed with the gradient and magnetic intensity will define the cut-off point of the magnetic fraction and the mixed fraction, namely: the positioning of the splitter 102.

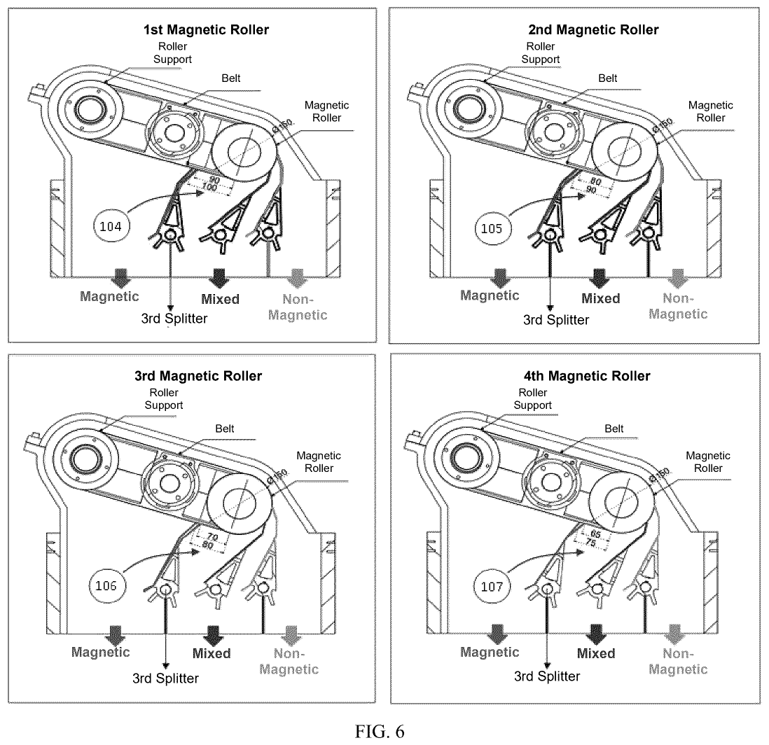

Preferred positioning of the aforementioned splitter 102 for four magnetic rollers of diameter equal to 150 mm and according to the present invention are explained in FIG. 6:
for a first magnetic roller, a positioning 104 between 90 mm and 100 mm;
for a second magnetic roller, a positioning 105 between 80 mm and 90 mm;
for a third magnetic roller, a positioning 106 between 70 mm and 80 mm; and
for a fourth magnetic roller, a positioning 107 between 65 mm and 75 mm.

Positioning 104, 105, 106 and 107 defined here can vary between 5 mm and 7 mm to more or less.

A greater positioning of splitter 102, that is, a greater distance from it to the center of the roll, indicates that the iron ore processed at this stage has greater magnetic susceptibility, that is, higher iron content. Such a configuration is observed in the first magnetic roller. The opposite is also true: a lower positioning of splitter 102 indicates that the iron mineral processed at this stage presents lower magnetic susceptibility, that is, lower iron content. Such a configuration is observed in the fourth magnetic roller.

The magnetic separation unit comprises from two to eight stages of mineral concentration. Thus, the magnetic separation unit comprises from two to eight magnetic rollers. In a preferred embodiment of the present invention, the magnetic separation comprises five concentration stages divided into two steps.

In the first step, a low intensity magnetic separation is conducted by means of a first magnetic roller of iron-boron permanent magnets with an intensity varying between 300 and 3500 Gauss, preferably between 750 and 1500 Gauss. In a preferred embodiment, said first magnetic roll has a diameter of about 240 mm to about 500 mm.

In the second step, a sequence of high intensity magnetic separations is conducted by means of magnetic rollers of rare earth magnets (iron-boron-neodymium) with varying intensity between 7500 and 14000 Gauss. In a preferred embodiment, four magnetic rollers are arranged in a cascade with an inclination angle between 5° and 55° and are from about 100 mm to about 500 mm in diameter. In a more preferred embodiment, said four magnetic rollers are arranged in a cascade with an inclination angle of 21° and have from about 150 mm to about 240 mm in diameter.

Each of the four magnetic rollers arranged in a cascade has different intensities, with the lowest intensity for the first roller and the highest intensity for the fourth roller. In this scope, the first roller will separate the minerals of higher magnetic susceptibility and consequently higher Fe (T) content and the fourth roller will separate the minerals of lower magnetic susceptibility and consequently lower Fe (T) content.

According to the present invention, each of the four magnetic rollers defined above has configurations with different magnet thicknesses for air gap thicknesses. Such configurations range from 3 mm to 20 mm, preferably between 3 mm and 15 mm, for the magnets and between 2 mm and 3 mm for the air gap. In a preferred embodiment, such configurations comprise a ratio of 13:1 to 4:3 of magnet thickness to air gap thickness.

It should be noted that magnetic intensity is greater the greater the ratio of magnet thickness to air gap thickness. Furthermore, the configurations proposed by the present invention, with high thicknesses of magnets combined with low thicknesses of the air gap, in addition to contributing to the reduction of costs associated with the system (in view of the cost associated with the magnets), present very high gradient and intensity and generate a small area of magnetic attraction (low depth of magnetic field, with 1 to 2 mm of the magnetic roller surface), providing an increase in the selectivity of the separation.

Moreover, the magnetic rollers of the present invention are preferably made by conjugating magnets of the same polarity (North) with an air gap in the middle followed by magnets of the same polarity (South) with an air gap in the middle, thus creating magnetic field lines that alternate along the magnetic roller.

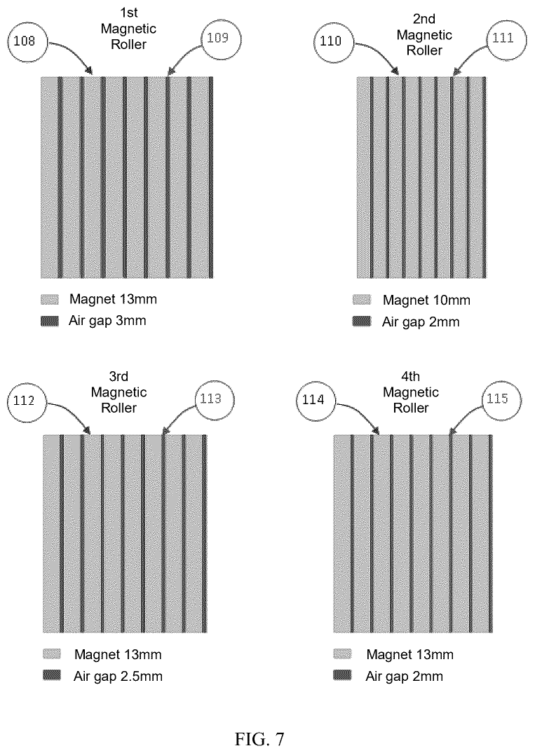

FIG. 7 shows a configuration for the four high intensity magnetic rollers of the separation unit proposed. The first magnetic roller with a configuration of magnet thickness 108 to air gap thickness 109 of 13 mm to 3 mm (4.3:1), generating a magnetic intensity of approximately 12500 Gauss. The second magnetic roller with a configuration of magnet thickness 110 to air gap thickness 111 of 10 mm to 2 mm (5:1), generating a magnetic intensity of approximately 12750 Gauss. The third magnetic roller with a configuration of magnet thickness 112 to air gap thickness 113 of 13 mm to 2.5 mm (5.2:1), generating a magnetic intensity of approximately 13000 Gauss. The fourth magnetic roller with a configuration of magnet thickness 114 to air gap thickness 115 of 13 mm to 2 mm (6.5:1), generating a magnetic intensity of approximately 13500 Gauss.

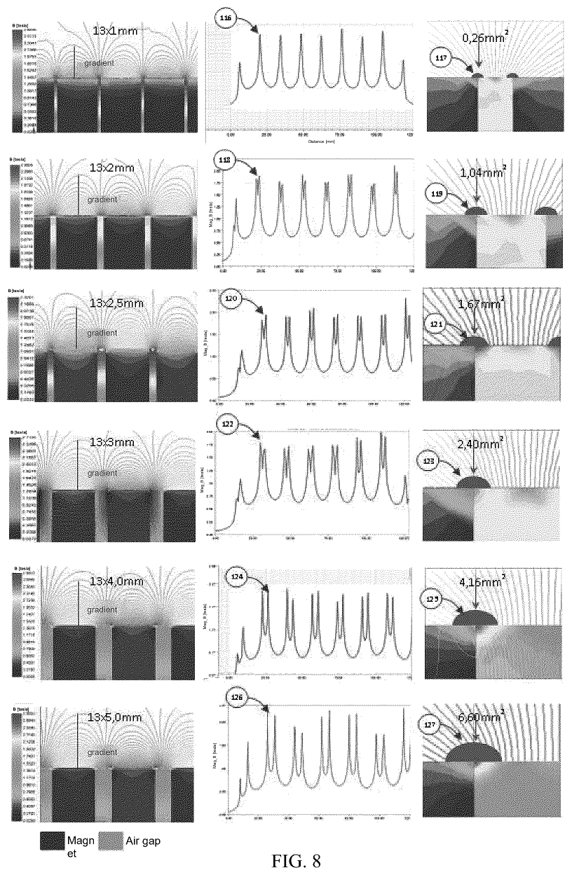

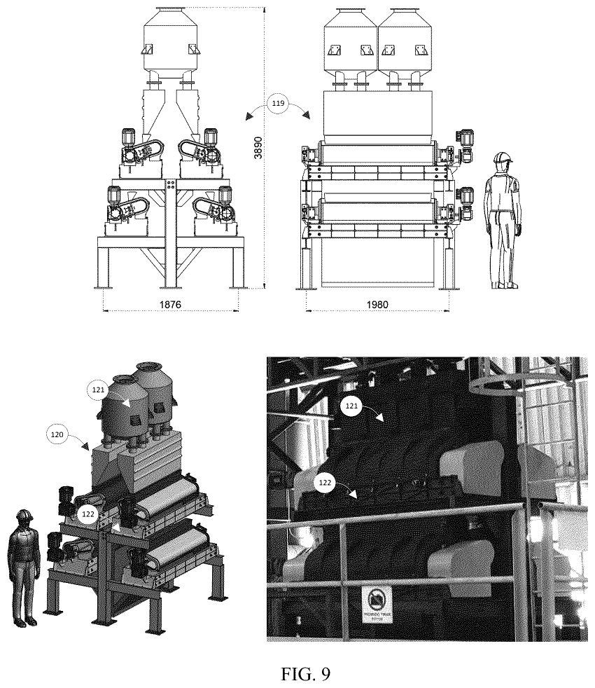

FIG. 8 demonstrates the influence of magnet and air gap thickness configurations on the formation of magnetic intensity peaks, as explained below.

For a configuration of 13 mm magnet thickness and 1 mm air gap thickness, higher magnetic intensity is observed with a single peak 116 and a high gradient with small magnetic attraction area 117 of 0.26 mm², and it can reach around 14000 Gauss or a little more.

For a configuration of 13 mm magnet thickness and 2 mm air gap thickness, a somewhat smaller gradient than above is observed, with the formation of two peaks 118 and an area of magnetic attraction 119 of 1.04 mm², reaching intensity around 13500 Gauss.

For a configuration of 13 mm magnet thickness and 2.5 mm air gap thickness, a somewhat smaller gradient than above is observed, with the formation of two peaks 120 and an area of magnetic attraction 121 of 1.67 mm², reaching intensity around 13000 Gauss.

For a configuration of 13 mm magnet thickness and 3 mm air gap thickness, a somewhat smaller gradient than above is observed, with the formation of two peaks 122 and an area of magnetic attraction 123 of 2.40 mm², reaching intensity around 12500 Gauss.

For a configuration of 13 mm magnet thickness and 4 mm air gap thickness, a somewhat smaller gradient than above is observed, with the formation of two peaks 124 and an area of magnetic attraction 125 of 4.16 mm², reaching intensity around 11500 Gauss.

For a configuration of 13 mm magnet thickness and 5 mm air gap thickness, a somewhat smaller gradient than above is observed, with the formation of two peaks 126 and an area of magnetic attraction 127 of 6.60 mm², reaching intensity around 10500 Gauss.

Also in view of achieving a very high selectivity of separation and therefore making it possible to obtain a product with very high Fe (T) content, the present invention proposes a speed of the magnetic rollers of up to 1600 rpm. Preferably, the speed of the magnetic rollers is between 300 rpm and 700 rpm.

Magnetic roller configurations proposed herein, coupled with a higher speed than that practiced by conventional magnetic roller separators, consists of an additional control of the magnetic separation unit and enables greater selectivity for obtaining a more pure magnetic concentrate and decreases the “trapping” effect.

Magnetic separation unit of the present invention makes it possible to obtain high purity iron ore concentrates with Fe contents higher than 67.5%.

FIG. 9 shows a block of four industrial-scale high intensity rare earth magnet magnetic separators as designed 119 and as built 120. To enable industrial scale construction, 122 castings, extruded components, stampings, CNC lathe machining, and low wear parts have been implemented in the making of plastic (PP) 121 injection molded and roto molded parts.

In view of the foregoing, the present invention proposes a new concentration route for enriching pellet feed with quality equal to or less than that suitable for the production of blast furnace pellet (Pellet Feed of Blast Furnace-PFAF) into pellet feed with quality suitable for the production of pellets for feeding the direct reduction steelmaking process (Pellet Feed of Direct Reduction-PFDR). Furthermore, it is important to point out that the present invention allows obtaining products of high added value without generating rejects, since the waste and the discarded fractions can be destined to the building industry (or, depending on the quality obtained, in the steel industry). Therefore, it is clear that the present invention constitutes an environmentally friendly solution for pellet feed enrichment.

Description that has been given so far of the subject matter of the present invention should be considered only as a possible embodiment(s), and any particular features introduced therein should be understood only as something that has been written for ease of understanding. Thus, they should not be considered as limiting the invention, which is limited to the scope of the claims.

The examples that will be presented illustrate the reach of the products generated by means of the reprocessing/cleaner system and route for enrichment of pellet feed concentrate proposed herein.

### EXAMPLES

### Example 1

Initial tests were conducted on samples of mixtures of concentrate and mill tailings, with approximate contents of 65% Fe (t) and 62% Fe (t), respectively. Characterization of the samples is illustrated in Table 1 and 2.

TABLE 1
Chemical and particle size characterization
of sample Blend 01 - PFAF.
Blend 01 - PFAF

| % Fe(t) | % SiO2 | % Al2O3 | % P | PPC |
|---|---|---|---|---|
| 64.7 | 6.22 | 0.18 | 0.01 | 0.24 |

Particle size

| Fraction (mm/μm) | Cumulative % passing |
|---|---|
| 0.500 mm/500 μm | 100.00 |
| 0.150 mm/150 μm | 97.10 |
| 0.075 mm/75 μm | 72.82 |
| 0.045 mm/45 μm | 24.93 |
| 0.010 mm/10 μm | 0.61 |

TABLE 2
Chemical and particle size characterization
of sample Blend 02 - PFAF.
Blend 02 - PFAF

| % Fe(t) | % SiO2 | % Al2O3 | % P | PPC |
|---|---|---|---|---|
| 61.96 | 10.19 | 0.17 | 0.01 | 0.27 |

Particle size

| Fraction (mm/μm) | Cumulative % passing |
|---|---|
| 0.500 mm/500 μm | 99.06 |
| 0.150 mm/150 μm | 95.84 |
| 0.075 mm/75 μm | 66.73 |
| 0.045 mm/45 μm | 38.00 |
| 0.010 mm/10 μm | 6.13 |

Tables 3 and 4 present the results obtained after conducting the process of the present invention.

TABLE 3
Results for sample Blend 01 - PFAF.
Results Dry Concentration - Blend 01 PFAF

| | % | % | % | % | % | % |
|---|---|---|---|---|---|---|
| | Mass | Fe | SiO2 | Al2O3 | P | PPC |
| Concentrate | 93.95 | 68.52 | 0.87 | 0.15 | 0.01 | 0.17 |
| Tailings | 6.05 | 5.36 | 89.23 | 0.57 | 0.04 | 1.31 |

TABLE 4
Results for sample Blend 02 - PFAF.
Results Dry Concentration - Blend 02 PFAF

| | % | % | % | % | % | % |
|---|---|---|---|---|---|---|
| | Mass | Fe | SiO2 | Al2O3 | P | PPC |
| Concentrate | 89.12 | 68.61 | 0.9 | 0.15 | 0.01 | 0.18 |
| Tailings | 10.88 | 7.44 | 86.29 | 0.35 | 0.04 | 1.06 |

As can be seen, for sample Blend 01 PFAF a mass recovery of approximately 93% and a final content of 68.52% Fe (T) were achieved. Furthermore, for sample Blend 02 PFAF a mass recovery of approximately 90% and a final content of 68.61% Fe (T) were achieved. Therefore, products suitable for use as PFDR were achieved.

### Example 2

To prove the efficiency of the system and process proposed, a new sample of concentrate and mill tailings mixture was tested. Characterization of the sample is illustrated in Table 5.

TABLE 5
Chemical and particle size characterization
of sample Blend 03 - PFAF - Mill 02.
Blend 03 - PFAF - Mill 02

| % Fe(t) | % SiO2 | % Al2O3 | % P | PPC |
|---|---|---|---|---|
| 61.73 | 9.74 | 0.34 | 0.02 | 0.83 |

Particle size

| Fraction (mm/μm) | Cumulative % passing |
|---|---|
| 0.500 mm/500 μm | 99.67 |
| 0.150 mm/150 μm | 89.49 |
| 0.075 mm/75 μm | 58.15 |
| 0.045 mm/45 μm | 25.48 |
| 0.010 mm/10 μm | 1.49 |

Table 6 shows the result obtained after conducting the process of the present invention.

TABLE 6
Result for sample Blend 03 - PFAF - Mill 02.
Results Dry Concentration - Blend 03 - PFAF - Mill 02

| | % | % | % | % | % | % |
|---|---|---|---|---|---|---|
| Products | Mass | Fe | SiO2 | Al2O3 | P | PPC |
| Concentrate | 89.49 | 68.15 | 0.7 | 0.26 | 0.02 | 0.75 |
| Tailings | 10.51 | 7.16 | 86.71 | 1.05 | 0.02 | 1.55 |

As can be seen, a mass recovery of approximately 89.5% was achieved, with metallurgy above 98% and a final Fe (T) content of 68.15%. Therefore, products suitable for use as PFDR were achieved.

Since the results of the initial tests were satisfactory, new tests were conducted without mixing tailings with mill concentrate (concentrates from flotation processing plants were tested).

### Example 3

A set of 5 pellet feed concentrate samples from flotation processing plants were characterized and blended together.

The mineralogical, chemical and particle size characterizations of the samples are illustrated in Tables 7, 8 and 9, respectively.

TABLE 7
Mineralogical characterization of the PFAF samples.
Mineralogical Characterization of Pellet Feed of Blast Furnace

| | % | % | % | % | % | % |
|---|---|---|---|---|---|---|
| Sample | HC | HM | MA | GO | QZ | OT |
| PF01 | 91.24 | 0.08 | 0.45 | 5.51 | 2.25 | 0.46 |
| PF02 | 38.17 | 34.37 | 20.76 | 4.87 | 1.47 | 0.35 |
| PF03 | 16.22 | 47.98 | 16.75 | 13.55 | 5.11 | 0.39 |
| PF04 | 96.41 | 0.16 | 0.09 | 0.24 | 2.81 | 0.29 |
| PF05 | 22.4 | 43.19 | 5.38 | 24.21 | 3.24 | 1.52 |

HC—Compact Hematite / HM—Martite Hematite / Ma—Magnetite / GO—Goethite / QZ—Quartz / OT—Other

TABLE 8
Chemical characterization of the PFAF samples.
Chemical Characterization of Pellet Feed of Blast Furnace

| | % | % | % | % | % | % |
|---|---|---|---|---|---|---|
| Sample | Fe | SiO2 | Al2O3 | P | Mn | PPC |
| PF01 | 67.47 | 2.82 | 0.38 | 0.046 | 0.056 | 0.7 |
| PF02 | 67.95 | 1.87 | 0.29 | 0.033 | 0.078 | 0.76 |
| PF03 | 64.74 | 4.77 | 0.32 | 0.086 | 0.245 | 1.86 |
| PF04 | 67.53 | 2.58 | 0.21 | 0.015 | 0.07 | 0.32 |
| PF05 | 63.13 | 3.8 | 1.16 | 0.057 | 0.386 | 4.06 |

TABLE 9
Particle size characterization of the PFAF samples.
Particle size of Pellet Feed of Blast Furnace
Cumulative % passing

| Fraction (mm/μm) | PF01 | PF02 | PF03 | PF04 | PF05 |
|---|---|---|---|---|---|
| 0.500 mm/500 μm | 99.40 | 99.38 | 99.79 | 99.88 | 100.00 |
| 0.150 mm/150 μm | 90.22 | 87.81 | 91.14 | 97.87 | 96.03 |
| 0.075 mm/75 μm | 72.56 | 59.39 | 65.00 | 83.77 | 76.52 |
| 0.045 mm/45 μm | 48.54 | 29.86 | 38.39 | 45.99 | 44.70 |
| 0.010 mm/10 μm | 1.24 | 0.48 | 4.14 | 1.45 | 7.23 |

After the characterizations of the samples, a first blend formed with 20% blend PF01/PF03/PF05 and 80% blend PF02/PF04 was characterized. The characterization of this blend is illustrated in Table 10.

TABLE 10
Chemical and particle size characterization of the blend.
Characterization PF01/PF03/PF05 20% blend + PF02/PF04 80% blend

| % Fe | % SiO2 | % Al2O3 | % P | % Mn | % PPC |
|---|---|---|---|---|---|
| 67.73 | 2.02 | 0.22 | 0.03 | 0.1 | 0.96 |

Particle size

| Fraction (mm/μm) | Cumulative % passing |
|---|---|
| 0.500 mm/500 μm | 99.72 |
| 0.150 mm/150 μm | 94.42 |
| 0.075 mm/75 μm | 75.75 |
| 0.045 mm/45 μm | 42.00 |
| 0.010 mm/10 μm | 1.75 |

Table 11 shows the result obtained after conducting the process of the present invention.

TABLE 11
Result for the blend.
Results PF 01/ PF03/ PF 05 20% blend + PF 02 / 04 80% blend

| | % | % | % | % | % | % | % |
|---|---|---|---|---|---|---|---|
| Products | Mass | Fe | SiO2 | Al2O3 | P | Mn | PPC |
| Concentrate | 90.29 | 68.85 | 0.83 | 0.17 | 0.02 | 0.08 | 0.77 |
| Tailings | 9.71 | 57.26 | 13.06 | 0.69 | 0.06 | 0.3 | 2.70 |

As can be seen, a mass recovery of approximately 90.29% and metallurgical recovery of over 98% was achieved, with a final Fe (T) content of 68.85%. Therefore, products suitable for use as PFDR were achieved.

### Example 4

A second blend was formed by modifying the blend of Example 3 with 30% PF01/PF03/PF05 blend and 70% PF02/PF04 blend, and then the process route of the present invention was conducted. Table 12 shows the results obtained.

TABLE 12
Result for the blend.
Results PF01/PF03/PF05 30% blend + PF02/PF04 70% blend

| | % | % | % | % | % | % | % |
|---|---|---|---|---|---|---|---|
| Products | Mass | Fe | SiO2 | Al2O3 | P | Mn | PPC |
| Concentrate | 83.85 | 68.76 | 0.85 | 0.19 | 0.03 | 0.08 | 0.65 |
| Tailings | 16.15 | 58.06 | 12.74 | 0.71 | 0.06 | 0.29 | 2.54 |

After conducting the process of the present invention, a mass recovery of approximately 83.85% and a final Fe (T) content of 68.76% were achieved, considering the test with the 70/30 blend. Therefore, products suitable for use as PFDR were achieved.

All the tests described in the Examples above were conducted in the laboratory and demonstrated that the waste generated can be utilized in the steel industry.

Pilot scale tests were carried out to ratify the results obtained in the laboratory.

### Example 5

A sample of a blend of concentrate and mill tailings was tested on a pilot scale. Chemical and particle size characterization of this sample is illustrated in Table 13.

TABLE 13
Chemical and particle size characterization of the PF01 blend.
Characterization Pilot Test PF01

| % Fe | % SiO2 | % Al2O3 | % P | % Mn | % PPC |
|---|---|---|---|---|---|
| 67.26 | 2.96 | 0.211 | 0.016 | 0.065 | 0.575 |

Particle size

| Fraction (mm/μm) | Cumulative % passing |
|---|---|
| 0.500 mm/500 μm | 100.00 |
| 0.150 mm/150 μm | 98.05 |
| 0.075 mm/75 μm | 86.14 |
| 0.045 mm/45 μm | 48.98 |
| 0.010 mm/10 μm | 1.78 |

Table 14 shows the result obtained after conducting the process of the present invention.

TABLE 14
Result obtained for the PF01 blend.
Results PF01 - Pilot Plant

| | % | % | % | % | % | % | % |
|---|---|---|---|---|---|---|---|
| Products | Mass | Fe | SiO2 | Al2O3 | P | Mn | PPC |
| Concentrate | 88.88 | 68.79 | 0.98 | 0.19 | 0.01 | 0.05 | 0.49 |
| Tailings | 11.12 | 55.07 | 18.78 | 0.38 | 0.03 | 0.14 | 1.25 |

As can be seen, a mass recovery of approximately 89% and metallurgical recovery of over 98% was achieved, with a final Fe (T) content of 68.79%. Therefore, products suitable for use as PFDR were achieved.

### Example 6

A second sample of a mixture of concentrate and mill tailings was tested at pilot scale. Chemical and particle size characterization of this sample is illustrated in Table 15.

TABLE 15
Chemical and particle size characterization of the PF02 blend.
Characterization Pilot Test PF02

| % Fe | % SiO2 | % Al2O3 | % P | % Mn | % PPC |
|---|---|---|---|---|---|
| 66.97 | 3.16 | 0.3 | 0.04 | 0.08 | 0.86 |

Particle size

| Fraction (mm/μm) | Cumulative % passing |
|---|---|
| 0.500 mm/500 μm | 98.97 |
| 0.150 mm/150 μm | 87.70 |
| 0.075 mm/75 μm | 59.27 |
| 0.045 mm/45 μm | 31.75 |
| 0.010 mm/10 μm | 1.24 |

Table 16 shows the result obtained after conducting the process of the present invention.

TABLE 16
Result obtained for the PF02 blend.
Results PF 02 - Pilot Plant

| | % | % | % | % | % | % | % |
|---|---|---|---|---|---|---|---|
| Product | Mass | Fe | SiO2 | Al2O3 | P | Mn | PPC |
| Concentrate | 87.59 | 68.51 | 1.25 | 0.25 | 0.04 | 0.072 | 0.66 |
| Tailings | 12.41 | 56.12 | 16.63 | 0.65 | 0.05 | 0.17 | 2.28 |

As can be seen, a mass recovery of approximately 87.6% and a final Fe (T) content of 68.51% were achieved. Therefore, products suitable for use as PFDR were achieved.

Thus, the results obtained from pilot scale tests demonstrated the feasibility of applying the present invention beyond the laboratory scale.

1.-28. (canceled)

29. A dry magnetic concentration system of iron ore fine concentrates, comprising:
a drying unit comprising a dryer selected from a group consisting of fast type dryer with a mechanical stirring system, flash dryer, rotary, or fluidized bed;
a cooling unit comprising static or dynamic air classifiers, rotary coolers, column flash coolers, or fluidized bed; and
a magnetic separation unit comprising from two to eight magnetic rollers, wherein said magnetic rollers comprise at least three splitters, wherein a first magnetic roller is made up of permanent low-intensity iron-boron magnets and remaining magnetic rollers are made up of rare earth magnets of high intensity;
wherein the iron ore fine concentrates are from prior mineral concentration steps and have a Fe content ranging between about 58% and about 64%.

30. The dry magnetic concentration system according to claim 29, wherein the drying unit further comprises an exhaust fan for forced convection of a gas flow from the drying unit.

31. The dry magnetic concentration system according to claim 29, wherein the drying unit further comprises high-frequency cyclones for dedusting fines contained in a gas from the drying unit.

32. The dry magnetic concentration system according to claim 31, wherein the fines have particles smaller than 10 μm.

33. The dry magnetic concentration system according to claim 31, wherein the fines are retained in a process bag filter or electrostatic precipitator.

34. The dry magnetic concentration system according to claim 29, further comprising an air classification unit coupled to the cooling unit.

35. The dry magnetic concentration system according to claim 29, wherein the first magnetic roller of the magnetic separation unit includes the iron-boron permanent magnets having variable intensity between 300 and 3500 Gauss and about 240 mm to about 500 mm in diameter, and the remaining magnetic rollers of the rare earth magnets magnetic separation unit having variable intensity between 7500 and 14000 Gauss and about 100 mm to about 500 mm in diameter.

36. The dry magnetic concentration system according to claim 35, wherein the remaining magnetic rollers are arranged in a cascade with inclination angles between 5° and 55°.

37. The dry magnetic concentration system according to claim 35, wherein the remaining magnetic rollers are from about 150 mm to about 240 mm in diameter and are arranged in cascade with inclination angles of 21°.

38. The dry magnetic concentration system according to claim 36, wherein the remaining magnetic rollers have different intensities, a lowest intensity for a first of the remaining magnetic rollers arranged in cascade and a highest intensity for a last of the remaining magnetic rollers arranged in cascade.

39. The dry magnetic concentration system according to claim 36, wherein the remaining magnetic rollers have configurations ranging from 3 mm to 20 mm for the magnets and between 2 mm and 3 mm for air gaps.

40. The dry magnetic concentration system according to claim 39, wherein the remaining magnetic rollers have configurations that comprise a ratio of 13:1 to 4:3 of a thickness of the magnet to a thickness of the air gap.

41. A dry magnetic concentration process of the iron ore fine concentrates performed by the system of claim 29.

42. The process according to claim 41, wherein a drying step is conducted at a temperature in a range of about 80° C. to about 120° C.

43. The process according claim 41, wherein in a drying step, the iron ore fine concentrate unit is reduced to less than 0.5%.

44. The process according to claim 41, wherein a cooling step is conducted with intake of atmospheric air at room temperature.

45. The process according to claim 41, wherein in a cooling step, a temperature of the fine iron ore concentrate is reduced to less than 65° C.

46. The process according to claim 41, further comprising an air classification step after a cooling step.

47. The process according to claim 46, wherein in the air classification step, cutting of particles below 10 μm or above 150 μm is conducted.

48. The process according to claim 41, wherein magnetic separation comprises two to eight stages of concentration.

49. The process according to claim 48, wherein the magnetic separation comprises five stages of concentration divided into two steps, one step being a low-intensity step and another step being a high-intensity step.

50. The process according to claim 49, wherein a first step of the magnetic separation is conducted by the first magnetic roller of iron-boron permanent magnets having variable intensity between 300 and 3500 Gauss and about 240 mm to about 500 mm in diameter.

51. The process according to claim 49, wherein a second step of the magnetic separation is conducted by a remaining four rare earth magnets magnetic rollers having variable intensity between 7500 and 14000 Gauss and about 100 mm to about 500 mm in diameter.

52. The process according to claim 41, wherein the magnetic separation is conducted at a speed of the magnetic rollers between 300 rpm and 700 rpm.
